(19) United States
(12) Patent Application Publication
(10) Pub. No.: US 2019/0080538 A1
(43) Pub. Date: Mar. 14, 2019

(54) NOVEL HIGH ASSURANCE IDENTITY AUTHENTICATION AND GRANULAR ACCESS OVERSIGHT AND MANAGEMENT SYSTEM BASED ON INDOOR TRACKING, GPS AND BIOMETRIC IDENTIFICATION

(71) Applicant: Alex Shahidi, Santa Clara, CA (US)

(72) Inventor: Alex Shahidi, Santa Clara, CA (US)

(21) Appl. No.: 16/112,735

(22) Filed: Aug. 26, 2018

Related U.S. Application Data
(60) Provisional application No. 62/606,041, filed on Sep. 8, 2017.

(51) Int. Cl. G07C 9/00; H04L 29/06; H04L 9/06; H04W 4/029; H04W 4/02; H04W 4/80; H04L 29/08; H04L 12/66

(52) U.S. Cl. CPC G07C 9/00158; G07C 9/00087; G07C 9/00111; H04L 63/0861; H04L 63/102; H04L 9/0637; H04L 2209/38; H04W 4/025; H04W 4/80; H04L 67/12; H04L 12/66; H04L 2463/082; H04W 4/029

(57) ABSTRACT

The present invention relates to systems and methods for identity and access management. In one embodiment, a user access management system comprises an identification device (including a location system, an ambient sensor system, a biometric sensor system), an ambient space sensor system, an identification database including user biometric information, and a gateway server communicatively coupled to the identification device, the space sensor system, and the identification database. The gateway server is programmed to the location information, ambient information, and biometric information and to verify user identity and a secure path for the user using a blockchain log of the user location path.

This application claims priority to U.S. Provisional Patent Application No. 62/606,041 titled NOVEL HIGH ASSURANCE IDENTITY AND ACCESS MANAGEMENT SYSTEM BASED ON INDOOR TRACKING, GPS (GLOBAL POSITIONING) AND BIOMETRIC IDENTIFICATION and filed on Sep. 8, 2017, the disclosure of which is hereby incorporated herein by reference in its entirety.

### BACKGROUND

The present invention relates to systems and methods for identity authentication and access management and specifically to systems and methods based on indoor tracking, GPS (global positioning), biometric identification, and blockchain to enable a more precise, higher certainty and secure method of identification and authentication of people, employees and objects for managing and controlling access to any pre-defined indoor physical or logical location.

Multi-factor authentication (MFA) represents a common method to confirm user's claimed identity through the presentation of two or more different “factors” taken from what user knows (e.g., a password), what he has (e.g., a smart card), or what he is (e.g., biometrical systems). The use of multiple authentication factors to prove one's identity is based on the premise that an unauthorized actor is unlikely to be able to supply the factors required for access. If, in an authentication attempt, at least one of the components is spoofed, mimicked, copied, missing or supplied incorrectly, the user's identity is not established with sufficient certainty and access to the asset (e.g., a building or data) being protected by multi-factor authentication then remains blocked with appropriate warnings and signals disseminated to dashboard(s) and other systems as appropriate. The authentication factors of a multi-factor authentication scheme may include: some physical object in the possession of the user (such as a USB stick with a secret token, a bank card, a key, etc.), some secret known to the user (such as a password, PIN, TAN, etc.), and/or some physical characteristic of the user (biometrics) (such as a fingerprint, eye iris, voice, typing speed, pattern in key press intervals, etc.).

Knowledge factors are the most commonly used form of authentication. In this form, the user is required to prove knowledge of a secret to authenticate himself or herself. A password is a secret word or string of characters that is used for user authentication. This is the most commonly used mechanism of authentication. Many multi-factor authentication techniques rely on password as one factor of authentication. Variations include both longer ones formed from multiple words (a passphrase) and the shorter, purely numeric, personal identification number (PIN) commonly used for ATM access. Traditionally, passwords are expected to be memorized. Many secret questions such as “Where were you born?” are poor examples of a knowledge factor because they may be known to a wide group of people or be able to be researched.

Possession factors (“something the user and only the user has”) have widely been used for authentication for centuries, in the form of a key to a lock. The basic principle is that the key embodies a secret which is shared between the lock and the key, and the same principle underlies possession factor authentication in computer systems. A security token is an example of a possession factor. RSA SecurID token is an example of a disconnected token generator. Disconnected tokens have no connections to the client computer. They typically use a built-in screen to display the generated authentication data, which is manually typed in by the user. Connected tokens are devices that are physically connected to the computer to be used. Those devices transmit data automatically. There are several different types, including card readers, wireless tags and USB tokens.

A software token (a.k.a. soft token) is a type of two-factor authentication security device that may be used to authorize the use of computer services. Software tokens are stored on a general-purpose electronic device such as a desktop computer, laptop, PDA, or mobile phone and can be duplicated. This contrasts with hardware tokens, where the credentials are stored on a dedicated hardware device and therefore cannot be duplicated (absent physical invasion of the device).

Physical characteristic factors are factors associated with the user, and are usually biometric factors, including fingerprint, face, voice, or iris recognition. Behavioral biometrics such as keystroke dynamics can also be used.

A common MFA is the two-factor authentication (2FA), currently used for instance by ATMs that require a card (possession) and a pin-code (knowledge). Once authenticated with both the factors, users can access to the service for the duration of a session. In case of the ATM, this session has a temporal limit of few minutes. The ATM case illustrates two main key points: (1) there are some “challenges” (the different factors to show) followed by a very simple logic (If the user overcomes the challenges, he is allowed to withdraw money. This should not be the only logic.); and (2) there are some “temporary constraints” that regulate both the authentication process (the time to show the second factor after that the first one has been showed) and, most importantly, the duration of the authenticated session.

### SUMMARY

The present invention relates to systems and methods for identity Authentication and granular access management and specifically to systems and methods based on indoor tracking, GPS (global positioning), biometric identification, and blockchain to enable a more precise, higher certainty and secure method of identification and authentication of people, employees and objects for managing and controlling access to any pre-defined indoor physical, or logical location.

In an embodiment, the present invention comprises a user access management system that includes an identification device (including a location system, an ambient sensor system, and a biometric sensor system), an ambient space sensor system, an identification database including user biometric information, and a gateway server communicatively coupled to the identification device, the space sensor system, and the identification database. The gateway server is programmed to receive first location information from the identification device location system and store the first location information in a blockchain in the identification database. The gateway server is further programmed to receive second location information from the identification device location system and append the second location information to the first location blockchain in the identification database and to receive third location information from the identification device location system, verify the third location information is consistent with and follows from the first and second location information, and if so append the third location information to the first and second location blockchain in the identification database. The gateway server is also programmed to receive device ambient information from the identification device ambient sensor system, receive space ambient information from the ambient space sensor system, and compare the device ambient information with the space ambient information to verify the identification device is located in the space and receive device biometric information from the identification device biometric sensor system, receive the user biometric information from the identification database, and compare the device biometric information with the user biometric information to verify the identity of the user.

Additionally, the gateway server may be programmed to collect data associated with movement and track movement of the user and/or predict movement of the user by leveraging Data Science (Machine Learning and Artificial intelligence) and/or to determine a physical characteristic of the user's location.

In another embodiment, the system comprises a user access management system that includes an identification device and a gateway server communicatively coupled to the identification device and programmed to (1) verify the ambient context of the identification device and (2) verify a blockchained geographic location of the identification device.

Other embodiments and various examples, scenarios and implementations are described in more detail below. The following description and the drawings set forth certain illustrative embodiments of the specification. These embodiments are indicative, however, of but a few of the various ways in which the principles of the specification may be employed. Other advantages and novel features of the embodiments described will become apparent from the following detailed description of the specification when considered in conjunction with the drawings.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 illustrates an exemplary space in which the identity and access management system may be deployed.

FIG. 2 illustrates an exemplary deployment and components of the disclosed identity and access management system.

FIG. 3 illustrates an exemplary identification device.

FIG. 4 illustrates an exemplary identification device.

FIG. 5 illustrates an exemplary deployment and components of the disclosed identity and access management system.

### DETAILED DESCRIPTION

The present invention relates to systems and methods for identity authentication and granular access management and specifically to systems and methods based on indoor tracking, GPS (global positioning), biometric identification, and blockchain to enable a more precise, higher certainty and secure method of identification and authentication of people, employees and objects for managing and controlling access to any pre-defined indoor physical or logical location.

As described in detail below, the disclosed system architecture includes the following elements: one or more user device, checkpoints, a blockchain, and a Trust Committee Service. User devices include electronic device that follows the user during his or her journey inside the controlled space. A goal of the device is to keep the user inside the secure path defined by the system and limit or deny access otherwise. During the time, the device publishes information on the user position in the secure path under the form of Self Position Information (SPI). As a personal device, it is responsible for the communication and authorization towards the checkpoints and it is equipped with sensing and communication capabilities to interact with the environment and with other user devices.

Checkpoints are special areas where one or more controllers co-verify that the user is the one it claims to be and it is at the position/time it states through his or her user device. These security checks are performed through specific challenges such as physical-layer challenges actuated by various types of sensors, including light detection like Infrared or other heat mapping, or mobile and static robotic systems equipped with various video and sensor capabilities. Passing through the different checkpoints it is like to be subject to a series of different authentications scattered in all over the path that certify, at different levels, that a given user is in a given position at a given time. This information is written in the secure path in the form of Certified Position Information (CPI). The existence of a checkpoint may not be permanent as they can show up “on demand” using the IoT and sensory infrastructure available in the premise.

The data concurring to the creation of the secure path are committed on a distributed append-only system using blockchain technology to make the system more resilient against attacks and hacking attempts. A specific permissioned blockchain is devised and will be described in what follows. A permissioned blockchain validates the transactions according to the rules described below before storing in its append-only structure. This data serves as an authentication information base rather than as an authentication method: it logs previous successful and unsuccessful authentications attempts as well as the whole path of the user devices with the co-validation of checkpoints. Third parties such as the Trust Committee Service (described below) may use this information to determine an authentication level. CPIs are registered using multi-signature techniques.

Verification procedures are carried out by multiple actors inside this scenario. Using the information stored in the blockchain, actors perform checks on users according to custom rules (policies) and on the history of the nodes logged in the system. For instance, by having passed two checkpoints in the last half hour, a given user device can be considered “enough” authentic to access to some services while not for others. A Trust Committee Service (TCS) is a service provided by the secure path where a set of agents can provide verification checks about the current status of a user, providing a trust level expressed by a number in the range (e.g., 0, 10.0). This output, that must be written on the blockchain, is the results of an analysis of the history of the node and of the company policy.

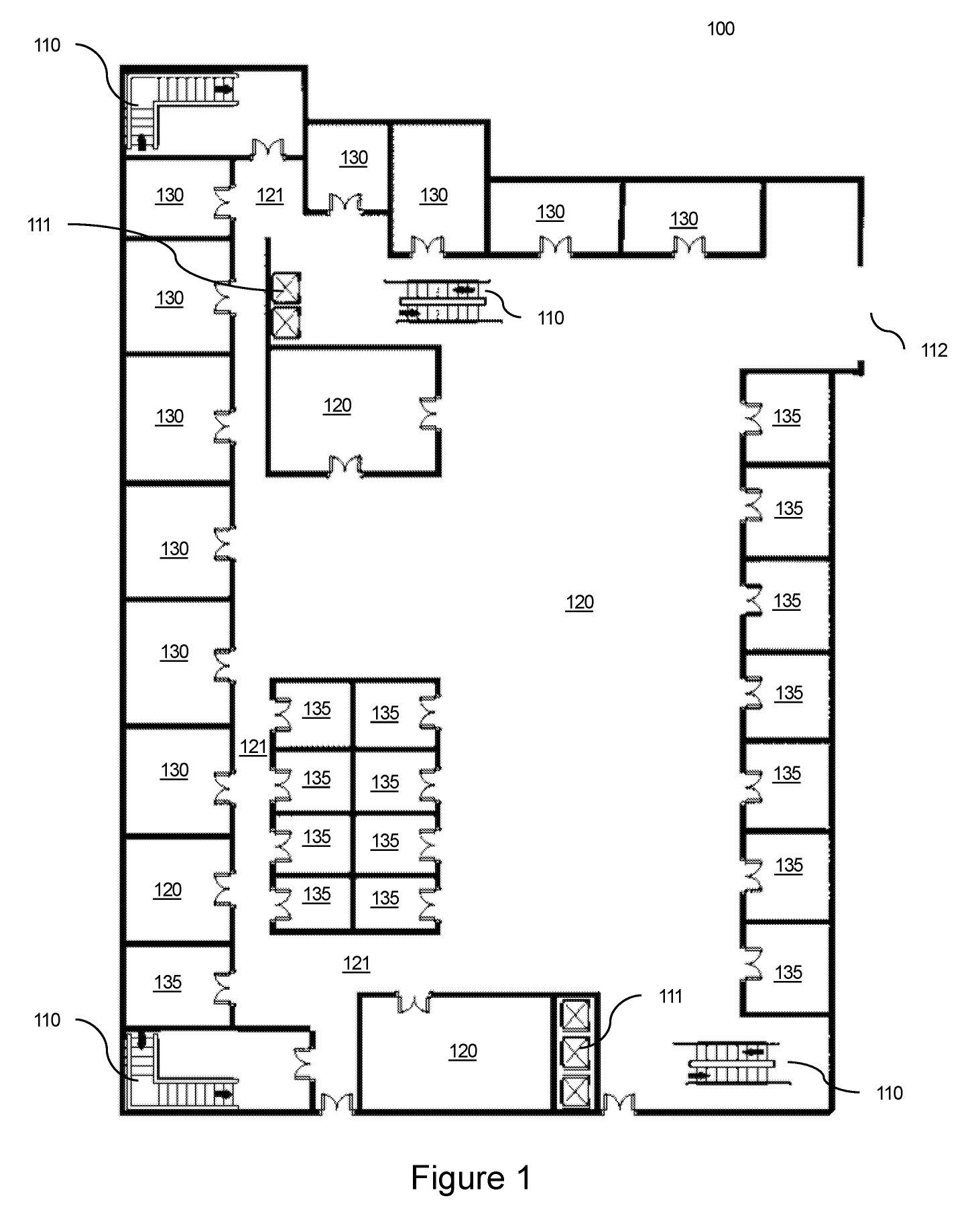

FIG. 1 illustrates an exemplary space 100 in which the present invention may be used and includes various hard and soft components that work together as described below to deliver a high-assurance identity authentication and granular access management and control system. In several possible working sequences and variations, this invention will allow and enable increasing levels of overall security as needed. FIG. 1 is an illustrative floor plan of the space 100 and, while shown in two dimensions, is representative of a real-world space in three dimensions and/or multiple floors. Similarly, the various hard and soft components shown may be distributed throughout the real-world space in three dimensions as required even though shown in two dimensions in FIG. 1. As shown, the space 100 may include stairs 110 and/or elevators 111 to multiple levels (not shown) that may be included in the space covered by the disclosed identity and access management systems. The space may include ingress and/or egress points 112 (which may include the stairs 110 and/or elevators 111) by which users may enter or leave the space 100. The system may include authentication requirement (or checkpoints) at the ingress/egress points 112 (including the stairs 110 and/or elevators 111).

The space 100 may include open or common areas 120 and hallways or corridors 121 through which users with various levels of access may pass. The space 100 may include rooms 120, 130, 135 into which users with various levels of access may pass. For illustration, rooms 120 are common areas requiring a first level of user access, rooms 130 require a second level of access, and rooms 135 require third level of access.

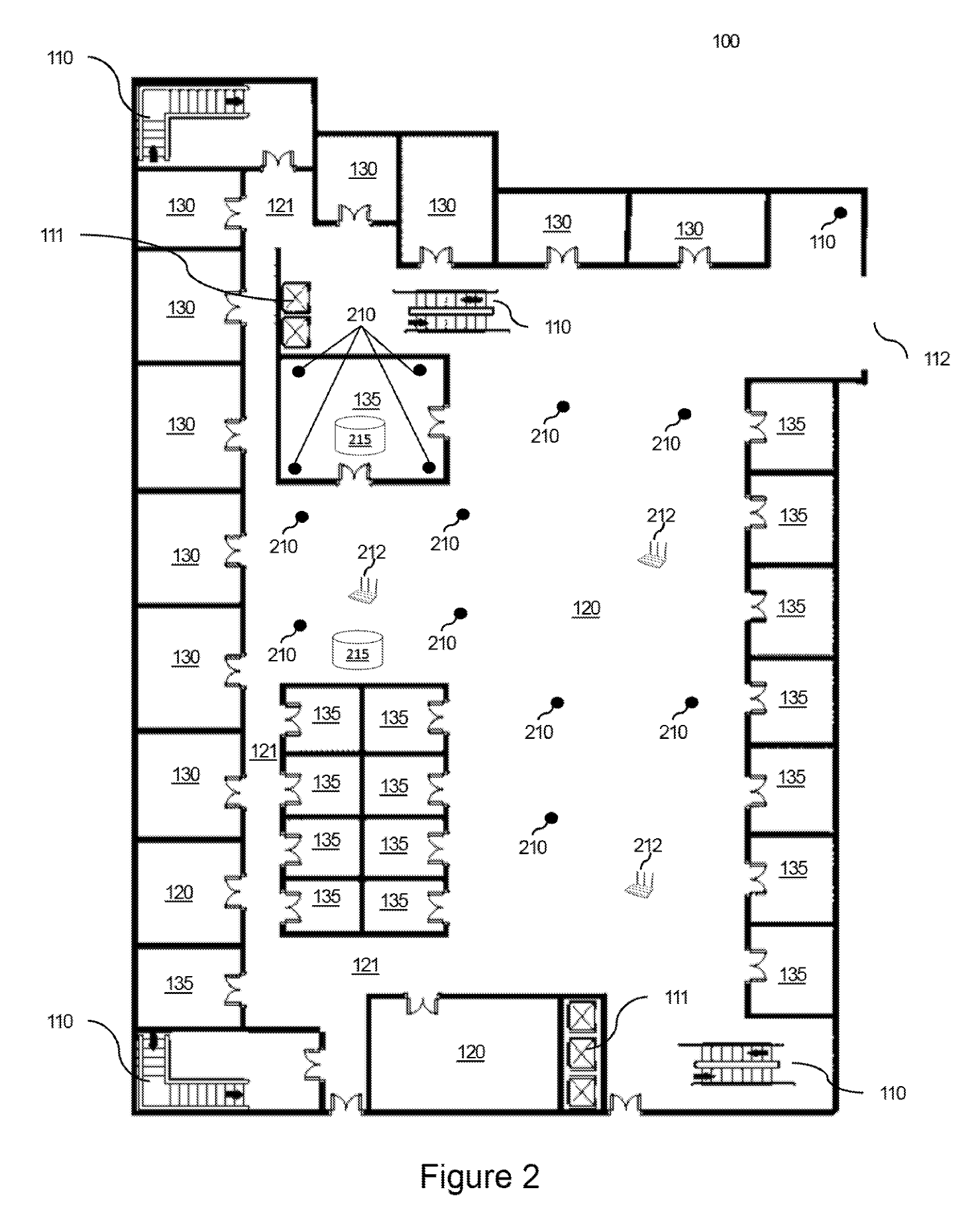

FIG. 2 is a further illustration of the space 100 shown in FIG. 1. As shown in FIG. 2, the space 100 may be equipped with sensors 210 of various kind as appropriate to type of physical space and utility and purpose. The sensors 210 are shown is some rooms for illustration but may be placed in any rooms according to need. Further, the sensors 210 may be distributed three dimensionally throughout each room as appropriate. The sensors 210 may be individual sensor or sensor arrays that can detect many signals including but not limited to: temperature, pressure, movement, humidity, barometric pressure, distance, proximity, Wi-Fi, speed, infrared radiation, sound, level, and gas. The sensors 210 come in many forms and shapes, maybe embedded or free-standing device or integrated with other devices including a router or gateway and transmit their detected signal to a gateway (or point of signal collection and processing) using various protocols including but not limited to: MQTT, BLE, Wi-Fi, LORA, Bluetooth, Lorawan, 6LoWPAN, and Zigbee.

The space 100 and/or each of the rooms 120, 130, 135 may also include one or more gateway 212 to collect sensory and other data in a database or datastore. The gateway 212 is optimally able to filter and process these data to allow an action, turn a device or equipment on or off, or send raw or processed data in a secure manner (i.e., SSL) to other point of processing and decision support (such as the master gateway server 215 discussed below or to a cloud server) for further analysis or action.

The space 100 and/or each of the rooms 120, 130, 135 may also include one or more master gateway server 215. The master gateway server 215 is a high-performance server or multiple connected servers able to filter, process, store, and analyze all incoming data and is intended to be the central processing, decision support, analytics, machine learning and artificial intelligence unit of the system. The number and size of servers can be architected in multiple ways and is determined by type of infrastructure in place, size of organization, data load, types and frequency of processing, number of modules and features in use and other considerations typical to server sizing and specification. The master gateway server 215 receives data from the gateway(s) 212 for additional or further processing, sending various signals and commands to the gateway(s) 212 and other devices and systems as needed or necessary. The master gateway server 215 also sends updates, configuration changes, policies including master security policy and controls to all gateways 215, and the cloud server as needed and depending on specific use case and architecture. The master gateway server 215 is configured to store data in a database or datastore and perform analytics with machine learning and artificial intelligence built into the server directly and/or via installation of third party software enabling these capabilities. System communications and logical access to outside of the physical space 100 and/or rooms 120, 130, 135 is managed and controlled by the master gateway server 215. This includes physical access control systems, API's, enterprise applications and third-party software and systems onsite or off premise or in the cloud.

The master gateway server 215 receives global positioning satellite (“GPS”) data that it uses to establish the “truth” of a physical location inside which sensors 210 and gateways 212 are delivering their functions, along with communications with biometric systems and data sources, and to allow for triangulation of all data and perform algorithmic analytics, to establish identity and location of a given person, employee or object with very high precision and assurance. The indoor location/tracking coupled with persistent (repeat of biometric signal read and validation at pre-determined intervals) biometric data together will provide a very high level of identity authentication assurance. Coupled with GPS this assurance increases even further. The master gateway server 215 may also include built in privacy software (third party or rule based PII and other private data) developed into the master gateway server 215) to allow for control and management of privacy aspects of this system in accordance with applicable laws and policies.

As a person or user enters the space 100 and/or rooms 120, 130, 135, the system detects and/or communicates with an identification device associated with the user. The person or user may be an employee or authorized service person granted ongoing or temporary access to the space 100 and/or rooms 120, 130, 135. Additionally, the system may be used to authorize access to the space 100 and/or rooms 120, 130, 135 by an object as well as a user.

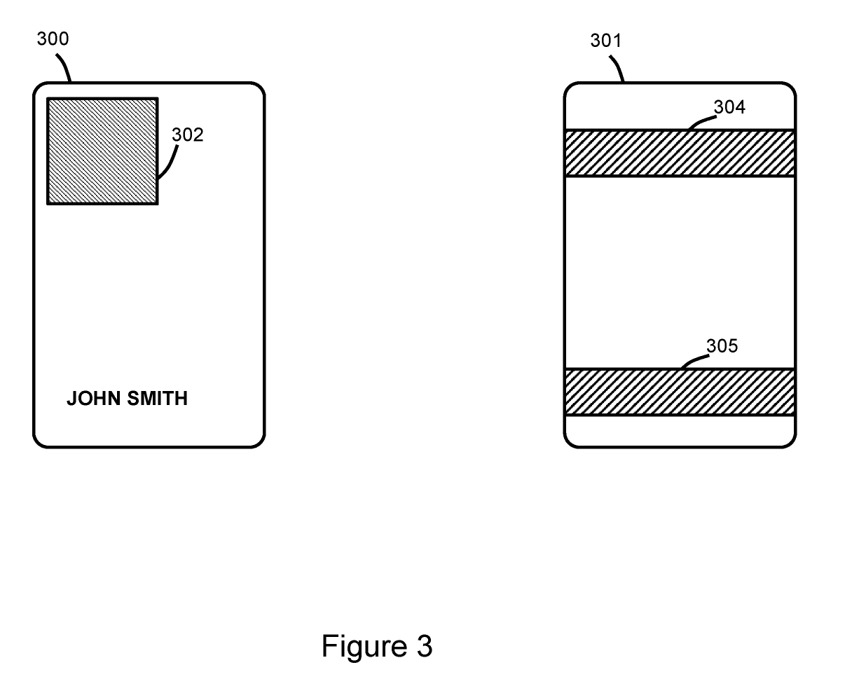

FIG. 3 illustrates an exemplary identification device 300. The identification device 300 shown in FIG. 3 is an identification badge, but the identification device used in the present system may be a card or similar device common to many business and residential places or an electronic device like a mobile device. The identification device 300 is typically equipped with electromagnetic device like a radio frequency ID chip (“RFID”) but also able to be equipped with many types of sensors (including fingerprint, biometric, temperature, pressure, movement, humidity, barometric pressure, distance, proximity, Wi-Fi, speed, infrared radiation, sound, level, and gas) to allow communication to the physical security system that opens doors, gates or other barriers to entry and exit. This The identification device 300 may be available in other forms including a pendant, wristband or other wearable device. As shown in FIG. 3, the identification device 300 may include a photograph 302 of the user. The identification device 300 may also include a magnetic stripe 304 including encoded information as well as a signature space 305 for additional user verification.

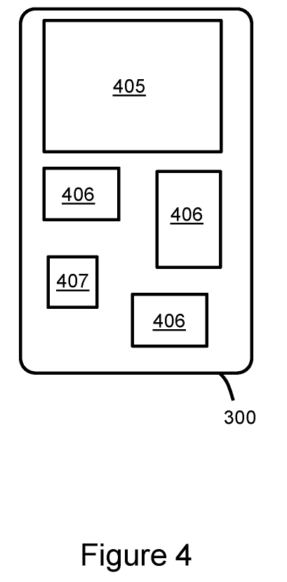

FIG. 4 illustrates some of the components that may be included in the identification device 300. The identification device 300 may include a power source 405 such as a battery. The identification device 300 may include biometric sensors 406 or readers such as fingerprint, IRIS, vein, cochlear, face recognition or other readers and may be equipped to receive authenticated data from a third-party biometric database. The identification device 300 may be equipped with chip 407 to send and receive data securely to the gateway 212 and/or master gateway server 215.

The system includes geolocation of the space 100 and/or rooms 120, 130, 135 provided from one of various available service providers like Google, Apple and MapQuest. This data is received via the master gateway server 215 and is used in analysis, triage and processing along with other data.

The present system may be implemented from the entry point(s) 112 (including the stairs 110 and/or elevators 111) of the space 100 or after initial entry from outside of physical space 100 and at point of entry of person, employee or object to various physical and logical entry points from that point forward. The sensors 210 provide data that used to determine the location of every person or object inside the physical space 100 and/or rooms 120, 130, 135 and send that information to nearest gateway 212 or master gateway server 215 as appropriate to specific type and density of required action or analysis. The biometric chip enabled badge/employee ID card 300 may read the user's biometric data seamlessly from a third-party biometric reader/system or by the user taking an action that allows the biometric chip in the badge to gather biometric data and send it to the nearest gateway 212 or master gateway server 215.

The master gateway server 215 receives all data securely from the gateway(s) 212 and validates against indoor location master data and biometric master data. If higher level of security and assurance is needed, then geolocation data from GPS provider will also be used in further validation. If validation is successful, the master gateway server 215 will communicate with appropriate enterprise application(s) for an access control list and access control policies of the enterprise or organization to grant physical and/or logical access thru API with physical or logical access control application. The machine learning of these data will help improve and enhance those policies over time.

For an organization with multiple and or global locations and employees or people biometric, GPS and indoor tracking data can be collected for all locations and various algorithms performed to detect unauthorized access or duplication of logical/physical entry or other anomaly. For example, a person validated and logged in via a specific location will automatically be prevented from duplicated login or entry from any and all other physical and logical locations.

A person (e.g., employee) or object equipped with or wearing an identification device 300 (e.g., badge, mobile device, employee card or a wearable ID Card) that is equipped with a biometric enabled chip or can securely communicate and send/receive info from a third party biometric reader gateway 212 or master gateway server 215, enters physical space 100 equipped with sensors 210, gateway 212 or master gateway server 215. The master gateway server 215 can receive and transmit global geolocation data from a GPS provider as well as data from the person or object, their identification device 300. Biometric info from the identification device 300 enabled to do it or third party biometric reader/service, and indoor location precisely calculated from sensory data of the physical space are all filtered, managed, processed and analyzed by the master gateway server 215 that is able to communicate with various software internal to organization or enterprise (internal systems and IT infrastructure and applications), or external to organization and enterprise (external systems and IT infrastructure and applications).

This invention may be used by any entity, organization of enterprise interested in combating the ever-growing security, hacking and theft of data risks from inside or outside of the organization or enterprise. This system may be used by fitting or retrofitting a physical space 100, 120, 130, 135 of any size with appropriate number and type of sensors 210 to detect various kinds of sensory signals that can be used for indoor tracking of people and objects. GPS data is readily available and maybe used by the master gateway server 215. There are many biometric identification systems currently in use that can be leveraged to manage the biometric aspect of this invention, and/or also a specific proprietary approach that maybe developed as part of this invention or licensed from various vendors. Either way the biometric data will be available directly or via secure API's for the processing by the master gateway server 215 for establishing identity and managing and controlling access with higher precision and assurance than currently available.

An advantage of this system is a higher level of Identification and authentication assurance than currently available or in use. This system allows for more seamless, convenient and higher assurance and security, while it reduces the overall dependence on traditional and common systems that rely on many techniques including behavioral analytics, IP tracing, usernames and passwords that are a necessity due to lack of sufficient assurance at the initial Identification and Authentication of the person accessing or needing access to controlled logical or physical spaces. It can also enable location and device specific login without the need for UN/PW.

There are potential variations in sequence of use of components in this invention without impacting the core functions and value of the system. There are also other uses for this type of system that are not purely due to need for better security but also for more convenient and automated access without sacrificing security.

In addition, the system may use a person's or object's location history to verify identity. For example, the system may use a person's or object's secure path in addition to the factors discussed above. A secure path is a time-series of spatial positions, successful and unsuccessful authentications, specific actions and relevant context information acquired through sensory data that describes the behavior of a person inside a controlled premise. This represents an authentication information base that can be used by algorithm to authenticate and/or authorize a user. Such information can be analyzed according to policies that describe to what extent this person can use the space or the equipment made available in a company premise as well as determine applications that will grant access; and whether a further authentication factor like a UN/PW or other token and further action is required

With the secure path, the system extends and strengthens the authenticated session considering multiple authentication procedures that take place inside a space (e.g., a company premise). For example, inside a company there are multiple “challenges”, that explicitly or implicitly authenticate and/or even control the authorization of an employee: from passing nearby the security guard, to the usage of a smart badge, from showing the face to fellow colleague or to a camera, to the conventional login with a username/password on a desktop computer. Moreover, with the revolution of the Internet of Things (IoT), the sensory environment can be programmed to further emphasize this supporting information flow, providing context information in the form of measurements data that can be used to corroborate an authentication thesis (e.g., to assess the possible exclusion of the hypothesis that a given person is in a given position at a given time).

Exploiting physical layer challenges, indoor position systems and blockchain technology, the secure path binds these authentication and sensory information together, bringing continuity and persistence, so that it is difficult to perform an identity theft in-between. This uses spatial and temporal information about the user to prevent session hijacking. At the same time, the union of multiple authentication techniques reinforce the validity of each single technique. Indeed, as for the case of multi-factor authentication, the combination of multiple techniques performs better than the sum of the parts as the spoofing of any factor does not compromise whole system validity. In this scenario it is clear then that a prominent role is covered by the infrastructure that hosts the information base needed for all the authentications methods to work together and been controlled.

The present system may use a blockchain composed by interconnected servers belonging to different (although not competitive) companies such as IT companies, insurance companies and/or third party “auditors.” Blockchain is used to log the information on the secure path so that the system leverages the integrity of the information and on the resiliency of the system to attacks. The system can resist to attacks that can compromise even N/2−1 of the servers (where N is the number of servers) and can detect attacks operation provided that at least one server is not involved in the attack. For example, if we have N=10 servers with the blockchain, an attack to 4 servers (N/2−1) would not compromise the service availability. This resiliency is a property of the blockchain. The trust committee is designed to have a similar property. This offers an extra protection against internal cybersecurity threats aimed to compromise the information base rather than on the single authentication procedure. This is a valuable security improvement as more than half of the attacks are carried out by insiders (according to the IBM 2016 Cyber Security Intelligence Index, 60% of attacks started from insiders). Blockchain validation prevents device to commit unauthorized transactions according to the rule defined by the chain and prevent attackers to cover their tracks through its append-only structure and distributed nature.

The system implements a secure path using the components described below. The system uses an identification device 300 this is an electronic device that follows the user during his or her journey inside the space 100 (note as described above, the same principles may be applied to the spaces and rooms 120, 130, 135). The identification device 300 can be a smart badge or a mobile device. The identification device 300 keeps the user or object inside the secure path. The identification device 300 publishes information on the user or object position in the secure path under the form of self-position information (“SPI”). The identification device 300 is responsible for communication and authorization towards the checkpoints and it is equipped with sensing and communication capabilities to interact with the environment and with other user devices.

The system comprises checkpoints that are special areas where one or more controllers verify that the user is the one it claims to be and is at the position/time stated through the identification device 300. These security checks are performed through specific challenges such as physical-layer challenges actuated by the IoT camera and/or sensors. Passing through the different checkpoints, the user is subject to a series of different authentications scattered in all over the path that certify, at a various level, that a given user is in a given position at a given time. This information is written in the secure path in the form of certified position information (“CPI”). The existence of a checkpoint may not be permanent and can show up “on demand” using the IoT infrastructure available in the premise.

The data created in the secure path are committed on a distributed append-only system that uses blockchain technology to make the system more resilient against internal attacks. The blockchain validates the transactions according to the rules described below to store in its append-only structure. These data serve as an authentication information base rather than as an authentication method: it logs previous successful and unsuccessful authentications attempts as well as the whole path of the user devices with the co-validation of checkpoints. Third parties such as the Trust Committee Service (TCS) (described below) may use this information to determine an authentication level. CPIs are registered using multi-signature techniques.

Verification procedures can be carried out by multiple actors in the system. Using the information stored in the blockchain, actors may perform checks on users according to custom rules (policies) and on the history of the nodes logged in the system. For instance, by having passed two checkpoints in the last half hour, a given user device can be considered sufficiently authenticated to access to some services or locations while not for others. A Trust Committee Service (TCS) is a service provided by the secure path where a set of agents can provide verification checks about the current status of a user, providing a trust level expressed by a number in a range (e.g., 0.0 to 10.0). This output, that is written on the blockchain, is the result of an analysis of the history of the node and of the company policy.

Operations are performed by various actors that can be co-located in the system. Checkpoints, for instance, before signing the position of a user might check his provenance by searching for the previous checkpoint he comes from, and they can decide whether or not to “certify” the user (i.e. signing its position and commit on the secure path). Doors might open only if a certain verification on the Secure Path are passed or delegate to the Trust Committee Service (TCS) the authentication. Other software (e.g., Intrusion Detection System (“IDS”)) can keep patrolling the secure path to spot anomalies.

To prevent attacks to the authenticator and to offer a higher level of resiliency, the identity verification/estimation is done by the Trust Committee. The Trust Committee may include a set of N different agents, with the same logic but deployed in different companies that have access to the blockchain. The goal of each member of the Trust Committee is to provide a value that describes numerically the estimation of the trust it associates to a user in the range 0-10. An N/M logic, i.e. it is enough that N members over the total M decide for a given vote to commit that vote on the chain, offers a protection against attacks to single members of the committee. In this framework, the Trust Committee can be build using a multi-signature.

The control of time plays a fundamental role in the authentication procedures: it regulates the duration of the sessions, giving a (temporal) constraint between the different steps of the authentication procedure, and determines the validity of each challenge, e.g. the time to insert a PIN code. However, differently from the identification of the challenges that received a much higher attention (e.g. research on OTP, biometrics etc.), the duration of a session has been very rarely engineered, but, more often, arbitrarily fixed (e.g. to one day or 6 hours). To provide a persistent authentication, the system binds the time constraint to the type of challenges and estimation outcome and, more generally, on the specific context. The duration of an authenticated session is enough to provide a sufficient protection against an identity spoofing or theft that may happen after a successful authentication (e.g. if we leave a desktop unattended after login). However, this probability is dependent by the context: for example, an internet point exhibits a totally different risk level than home. Moreover, time is not the only available dimension. With the recent advances in UWB (Ultra-wideband) and indoor localization system, it is possible to easily know the position of persons with a high level of precision (currently commercial products offer precision of about 12 cm). Secure Path ties together the multiple challenges by time and space. This gives the temporal and spatial perimeter of the authenticated session. With physical layer challenges, it is possible to prevent location-based attacks such as location spoofing or wormhole attacks. Exploiting physical layer challenges, indoor position systems together with the challenges mechanism, the Secure Path wants to bind the sensory information together, bringing continuity and persistence, so that it is difficult to perform an identity theft in-between. Incremental volumes of sensory data collected for location and user analysis, that are leveraged by Machine learning techniques will further allow detection of anomalies in the sensory networks themselves should they be exposed to hacking or other attack that impacts the “normalcy” and expected signal type, range and frequency.

At the same time, the union of multiple authentication techniques reinforce the validity of each single technique: indeed, as for the case of MFA, the combination of multiple techniques performs better than the sum of the parts as the spoofing of any factor does not compromise whole system validity. At the same time, the uses spatial and temporal information about the user to prevent session hijacking.

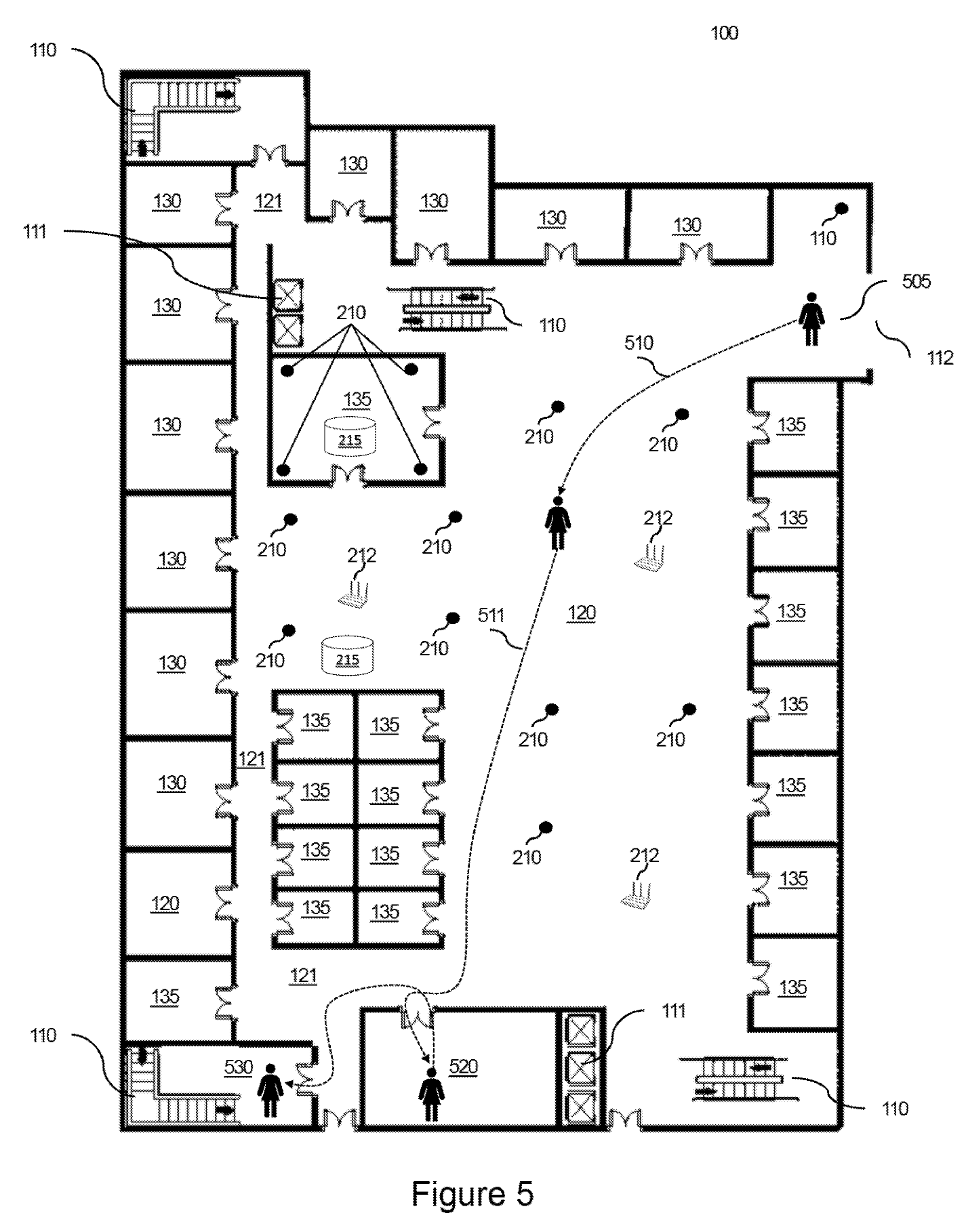

FIG. 5 shows the path 510, 511 of a user 505 through the space 100 as shown in FIGS. 1 and 2. When a user 505 enters in the space 100 (e.g., a company premise) the user equips her identification device 300. The identification device 300 periodically reports its position on the blockchain in the form of self-position information, signed with the user biometric key. The user 505 may, for example, pass a guard post (at entrance 112) controlled by a “guard” that can be either automated or a person. The guard physically check the identification device 300 of the user 505. Then the checkpoint device co-signs (using a multi-signature) the position of the identification device 300. The blockchain registers the check action (e.g. “check-type: CHECK-ID”), the time, and the positions. Then the user 505 is allowed to enter in the administration office 520 where she must register (e.g., badge) her entrance at a second checkpoint. Once she passes the badge control, the second checkpoint may verify if she passed the first checkpoint less than 15 minutes ago and may refuse to co-sign her data if its verification process fails. In this case, the second checkpoint can log the reason of its choice. Between administration office 520 and the stairway 530, there is a door that opens only if the user has passed checkpoint two in the administration office 520 recently. Then the user 505 passes through the stairway until she reaches the meeting room on the second floor (not shown) where she is captured by a security camera and her face will be recognized through a face detection algorithm. This is the third checkpoint that co-signs the certified position information. In the meeting room, the user 505 may want to use a desktop computer. The software on that computer contacts the Trust Committee Service (TCS) that returns a value of trust of the identification device 300 (e.g., 8.5). Then the operating system decides not to ask the user for the password (or only requests a single password) and let her automatically login. Alternatively, the computer may ask the user for a password and log the result of the challenge on the blockchain, becoming checkpoint four.

The system provides a more secure global enterprise authentication system that will authenticate the physical location of access and securely track users and mitigate spoofing of site and location. Additionally, the system may anonymize data by assigning a sequential or random number to each person/biometric to allow for privacy management and compliance with rules like the European General Data Protection Regulation (GDPR).

In the present specification, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should generally be construed to mean “one or more” unless specified otherwise or clear from context to be directed to a singular form.

In addition, the terms “example” and “such as” are utilized herein to mean serving as an instance or illustration. Any embodiment or design described herein as an “example” or referred to in connection with a “such as” clause is not necessarily to be construed as preferred or advantageous over other embodiments or designs. Rather, use of the terms “example” or “such as” is intended to present concepts in a concrete fashion. The terms “first,” “second,” “third,” and so forth, as used in the claims and description, unless otherwise clear by context, is for clarity only and does not necessarily indicate or imply any order in time.

What has been described above includes examples of one or more embodiments of the disclosure. It is, of course, not possible to describe every conceivable combination of components or methodologies for purposes of describing these examples, and it can be recognized that many further combinations and permutations of the present embodiments are possible. Accordingly, the embodiments disclosed and/or claimed herein are intended to embrace all such alterations, modifications and variations that fall within the spirit and scope of the detailed description and the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A user access management system comprising:
an identification device including a location system, an ambient sensor system, and a biometric sensor system;
an ambient space sensor system;
an identification database including user biometric information;
a gateway server communicatively coupled to the identification device, the space sensor system, and the identification database and programmed to:
(a) receive first location information from the identification device location system and store the first location information in a blockchain in the identification database;
(b) receive second location information from the identification device location system and append the second location information to the first location blockchain in the identification database;
(c) receive third location information from the identification device location system, verify the third location information is consistent with and follows from the first and second location information, and if so append the third location information to the first and second location blockchain in the identification database;
(d) receive device ambient information from the identification device ambient sensor system, receive space ambient information from the ambient space sensor system, and compare the device ambient information with the space ambient information to verify the identification device is located in the space; and
(e) receive device biometric information from the identification device biometric sensor system, receive the user biometric information from the identification database, and compare the device biometric information with the user biometric information to verify the identity of the user.

2. The system of claim 1 wherein the gateway server is programmed to track movement of the user.

3. The system of claim 1 wherein the gateway server is programmed to predict movement of the user.

4. The system of claim 1 wherein the gateway server is programmed to determine a physical characteristic of the user's location.

5. The system of claim 1 wherein the gateway server is further programmed to compare the third location information to space location information to verify the user is located in the space.

6. The system of claim 1 wherein the space ambient sensor system includes one or more sensor selected from the group consisting of: temperature sensors, pressure sensors, movement sensors, humidity sensor, barometric sensors, distance sensor, proximity sensors, Wi-Fi sensors, speed sensors, infrared sensors, sound sensors, level sensors, chemical sensors, and gas sensors.

7. The system of claim 1 wherein the identification device ambient sensor system includes one or more sensor selected from the group consisting of: temperature sensors, pressure sensors, movement sensors, humidity sensor, barometric sensors, distance sensor, proximity sensors, Wi-Fi sensors, speed sensors, infrared sensors, sound sensors, level sensors, chemical sensors, and gas sensors.

8. The system of claim 1 wherein the ambient sensor system includes one or more embedded sensor.

9. The system of claim 1 wherein the ambient sensor system includes one or more standalone sensor.

10. The system of claim 1 wherein the gateway server is configured to receive the information via MQTT, BLE, WiFi, LORA, BLE, Bluetooth, Lorawan, 6LoWPAN, or Zigbee.

11. The system of claim 1 wherein the gateway server comprises a remote gateway and a remote server.

12. The system of claim 1 wherein the identification device is selected from the group consisting of: a badge, an employee identification card, an RFID card, a pendant, a wristband, a wearable device, a mobile device, and a cell phone.

13. The system of claim 1 wherein the identification device biometric sensor system includes a sensor selected from the group consisting of: a fingerprint sensor, an IRIS sensor, a vein sensor, a cochlear sensor, and a face recognition sensor.

14. The system of claim 1 wherein the identification device further comprises a secure communication system for sending and receiving data securely to and from the gateway server.

15. A user access management system comprising:
an identification device and a gateway server communicatively coupled to the identification device and programmed to (1) verify the ambient context of the identification device and (2) verify a blockchained geographic location of the identification device.

16. The system of claim 15 wherein the gateway server is further programmed to compare location information for the identification device to space location information.

17. The system of claim 15 wherein the gateway server is programmed to verify the ambient context of the identification device by:
a. receiving ambient information from the identification device, receive space ambient information from an ambient space sensor system, and comparing the device ambient information with the space ambient information to verify the identification device is located in the space.

18. The system of claim 17 wherein the space ambient information includes information from one or more sensor selected from the group consisting of: temperature sensors, pressure sensors, movement sensors, humidity sensor, barometric sensors, distance sensor, proximity sensors, Wi-Fi sensors, speed sensors, infrared sensors, sound sensors, level sensors, chemical sensors, and gas sensors.

19. The system of claim 17 wherein the identification device ambient sensor information system includes information from one or more sensor selected from the group consisting of: temperature sensors, pressure sensors, movement sensors, humidity sensor, barometric sensors, distance sensor, proximity sensors, Wi-Fi sensors, speed sensors, infrared sensors, sound sensors, level sensors, chemical sensors, and gas sensors.

20. The system of claim 17 wherein the space ambient information includes information from one or more embedded sensor.

21. The system of claim 17 wherein the space ambient information includes information from one or more standalone sensor.

22. The system of claim 15 wherein the gateway server is configured to communicate with the identification device via MQTT, BLE, WiFi, LORA, BLE, Bluetooth, Lorawan, 6LoWPAN, or Zigbee.

23. The system of claim 15 wherein the gateway server comprises a remote gateway and a remote server.

24. The system of claim 15 wherein the identification device is selected from the group consisting of: a badge, an employee identification card, an RFID card, a pendant, a wristband, a wearable device, a mobile device, and a cell phone.

25. The system of claim 15 wherein the gateway server is programmed to receive device biometric information from the identification device, receive user biometric information from a database, and compare the device biometric information with the user biometric information to verify the identity of the user.

26. The system of claim 25 wherein the identification device biometric information includes information from a sensor selected from the group consisting of: a fingerprint sensor, an IRIS sensor, a vein sensor, a cochlear sensor, and a face recognition sensor.

27. The system of claim 15 wherein the gateway server is programmed to verify the blockchained geographic location of the identification device by:
a. receiving first location information from the identification device and storing the first location information in a blockchain;
b. receiving second location information from the identification device and appending the second location information to the first location blockchain;
c. receiving third location information from the identification device, verifying the third location information is consistent with and follows from the first and second location information, and if so appending the third location information to the first and second location blockchain.

28. The system of claim 15 wherein the identification device further comprises a secure communication system for sending and receiving data securely to and from the gateway server.
